(19) United States
(12) Patent Application Publication
(10) Pub. No.: US 2011/0169931 A1
(43) Pub. Date: Jul. 14, 2011

(54) IN-VIVO IMAGING DEVICE WITH DOUBLE FIELD OF VIEW AND METHOD FOR USE

(76) Inventors: Amit PASCAL, Haifa (IL); Haim Bezdin, Rishon Le'Zion (IL)

(21) Appl. No.: 12/986,384

(22) Filed: Jan. 7, 2011

Related U.S. Application Data
(60) Provisional application No. 61/294,232, filed on Jan. 12, 2010.

(51) Int. Cl. H04N 7/18

(52) U.S. Cl. 348/68; 348/E07.085

(57) ABSTRACT

An in-vivo imaging device incorporating a double field of view imaging system, having a wide field of view with moderate magnification, and a narrow field of view with substantially higher magnification, axially superimposed thereon. A single imaging array is used for both fields of view. At least some of the optical elements are shared between both of the two different field of view imaging systems. The imaging elements for the high magnification system, being of substantially smaller diameters than those of the low magnification system, are disposed coaxially with the imaging elements of the low magnification system, and can thus use the same imaging array without the need for deflection mirrors, beam combiners or motion systems. Their location on the axis of the low magnification system means that a small part of the imaging plane, around its central axis, is blocked out by the high magnification components.

### PRIOR APPLICATION DATA

The present application claims the benefit of prior U.S. provisional application No. 61/294,232, entitled “IN VIVO IMAGING DEVICE WITH DOUBLE FIELD OF VIEW”, filed on Jan. 12, 2010, incorporated by reference herein in its entirety.

### FIELD OF THE INVENTION

The present invention relates to the field of imaging systems capable of generating images at a number of magnifications in a static configuration, especially for use in systems requiring magnifications widely different by one or more orders of magnitude.

### BACKGROUND OF THE INVENTION

There exist many applications where an imaging system is intended to generate a general view of the surveilled region, but where it is desired to obtain a “microscope view” having a substantially higher magnification, when a region of interest is detected in the general view. An example of such a requirement exists in the endoscopic or capsule-based imaging of the interior of a gastro-intestinal tract.

Autonomous swallowable capsules exist. In such applications, the imaging system may be able to be able to view continuous sections of the gastrointestinal (GI) tract at low magnification and over a large field of view in order to cover a sufficient area in an acceptable time. When an area of interest is detected at this magnification, it may be desired to view the area at substantially higher magnification.

For endoscope systems, for example, details of the order of 0.1 mm have to be detected at the lower magnification level, but it may be desired to image details down to for example 1 to 2 microns at a high magnification level.

This is not generally feasible for usually available systems. The use of a high resolution imaging array in order to obtain the desired magnification, together with a wide field of view, is economically unachievable.

The combination of:

(i) very high resolution, with
(ii) a large field of view, and
(iii) imaged with the currently used detector arrays,
is generally impossible to achieve in currently available static, single bore, optical imaging systems.

Imaging systems incorporating zoom functions exist. However, it is not always possible to incorporate in a device the motion mechanisms necessary for constructing such a zoom lens imaging system. Furthermore, the ratio between minimum and maximum magnifications in such a zoom system is generally limited to a factor of about 10, such that to obtain a higher ratio of magnifications, two elements have to be zoomed independently, which is a complex and costly solution.

### SUMMARY OF THE INVENTION

In one embodiment it is possible to obtain a high range of magnifications in a single optical system. An imaging array with a very high density of pixels in the central area may be used. With properly designed optics such a high density of pixels enables the details of a high magnification image to be resolved. In prior art systems, since except for very high volume use, it is not cost effective to produce a dedicated array with smaller pixel size in the center region where the high magnification image falls, the whole imaging array typically has a pixel size commensurate with the high magnification image resolution. Currently used detector arrays for such applications, whether CMOS or CCD, typically have up to 400×400 pixels for small devices. In order to obtain the desired high resolution at the center of the image, the pixel count would have to be some tens of thousands by tens of thousands.

One of the three criteria of very high resolution, with a large field of view, and imaged with the currently used detector arrays, would have to be relaxed if an imaging system according to the current state of the art, were to be used to achieve the goals outlined above.

An embodiment of the present invention includes an autonomous swallowable device such as a capsule, for the inspection or imaging of the inner walls of a lumen, and which includes a double field of view imaging system, simultaneously having a wide field of view with moderate magnification, and a narrow field of view having substantially higher magnification. Such optical systems can also be used for incorporating into endoscopic devices. Some embodiments differ from prior art systems in that they use a single imaging array for both fields of view (FOV). Some embodiments also differ from prior art systems in that they generally have static optical element arrangements in which at least some of the elements are shared between both of the two different FOV imaging systems. The imaging elements for the high magnification system, having a much smaller field of view, and being of substantially smaller diameters than those of the low magnification system, may be disposed coaxially with the imaging elements of the low magnification system and can thus use the same imaging array without the need for deflection mirrors, beam combiners or motion systems. Their location on the axis of the low magnification system means that a small part of the imaging plane of the low magnification system, around its central axis, is blocked out by the high magnification components. However, careful design of the two lens sets can limit this blocked region to between 5° and 10°. The different useful aperture diameters at different magnifications may be related to different F-numbers, which may be chosen according to design preferences.

A typical requirement of such a double field of view/double resolution system may be for a range of magnifications of up to 100 (other ranges may be used). The increased resolution may require a larger numerical aperture and an increased effective focal length for the lens group, nearly in the same ratio as the increased resolution. Thus, the high magnification optical system may have a focal length of the order of 100 longer than that of the low magnification system. That part of the optical system close to the axis, which handles the high magnification field, may be designed with that performance in mind. This axial part may be generated by use of lenses having different central and peripheral form, or by implanting into the central region of the low magnification lenses, separate lenses for the high magnification application.

Use of such a system may enable a conventional imaging array to be used, without the need to use unduly small pixel sizes, since the pixels in the central area of the imaging array receive a more highly magnified image than those in the periphery, such that the same uniform, moderate pixel density, can resolve the finer details of the object in the region of high magnification.

One exemplary implementation involves a device for the inspection of the inside wall of a lumen, the device including:
an elongate housing for passage down the lumen,
a source for illumination of the inside of the lumen, and
an optical imaging system for imaging the inside wall, the optical imaging system including a two-dimensional detector array, a wide field of view imaging system for providing a first image of an object on the detector array, the first image having a first magnification relative to the object, and a narrow field of view imaging system for providing a second image of part of the object on the detector array, the second image of part of the object having a second magnification greater or substantially greater than the first magnification. The narrow field of view imaging system may include lenses disposed axially within the wide field of view imaging system. Both of the imaging systems may utilize at least one common lens to project an image onto the detector array.

In such a device, the detector array may have a uniform array of pixels, and the first image may be capable of providing substantially higher amount of details of information of the object than the second image by virtue of the fact that it images over a wider area (depending on the relative areas imaged in each image). Conversely, the second image may be capable of providing substantially higher magnification using the narrow field of view system. The detector array may provide a composite image with the second image occupying its central section, and the first image occupying its periphery. In such a case, each part of the composite image can be brought into focus by moving the system relative to the object. As an alternative, the system may include a focusing mechanism for adjusting the position of an element of either the wide field of view imaging system or the narrow field of view imaging system. Each part of the composite image should then be capable of being focused without the need to move the system relative to the object.

In further exemplary implementations of the above described devices, the at least one common lens may include a lens disposed in front of the detector array for focusing both of the first and the second images onto the array. The detector array may be a CCD array, a CMOS array or an infrared (IR) imaging array, or another suitable array.

In any of the above described devices, the second image may have a magnification larger or substantially larger than that of the first image. Furthermore, this range of magnification may be obtained without the need of a zoom mechanism.

### BRIEF DESCRIPTION OF THE DRAWINGS

The presently claimed invention will be understood and appreciated more fully from the following detailed description, taken in conjunction with the drawings in which:

FIG. 1 illustrates schematically a swallowable capsule incorporating double field of view imaging optics, according to one embodiment of the invention;

FIG. 2 illustrates schematically an exemplary imaging system for providing a wide field of view image of an object at a low magnification level, according to one embodiment of the invention;

FIG. 3 illustrates schematically an exemplary imaging system for providing a narrow field of view image of part of an object, at a high magnification level, according to one embodiment of the invention;

FIG. 4 illustrates schematically an exemplary imaging system obtained by combining the systems shown in FIGS. 2 and 3, into one composite system having a double field of view function, according to one embodiment of the invention;

FIG. 5 illustrates an example of the images seen on the display of the system of FIG. 4, when the system is disposed at such a distance from the object that the high magnification image is defocused, according to one embodiment of the invention;

FIG. 6 illustrates an example of the images seen on the display of the system of FIG. 4, when the system is disposed at such a distance from the object that the high magnification image is optimized/focused, according to one embodiment of the invention; and

FIG. 7 is a flowchart illustrating a method according to one embodiment of the invention.

### DETAILED DESCRIPTION

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well known features may be omitted or simplified in order not to obscure embodiments of the invention described herein.

Examples of devices and systems which may be used with embodiments of the present invention are for example those described in US Patent Application Publication Number 2006/0074275, entitled “System and Method for Editing an Image Stream Captured In-Vivo”, U.S. Pat. No. 5,604,531 to Iddan et al., entitled “In-vivo Video Camera System”, and/or in U.S. Pat. No. 7,009,634 to Iddan et al., entitled “Device for In-Vivo Imaging”, all of which are hereby incorporated by reference, each in its entirety. Such capsules may include or be associated with imaging, receiving, processing, storage and/or display units suitable for use with the capsule. Other systems may be used.

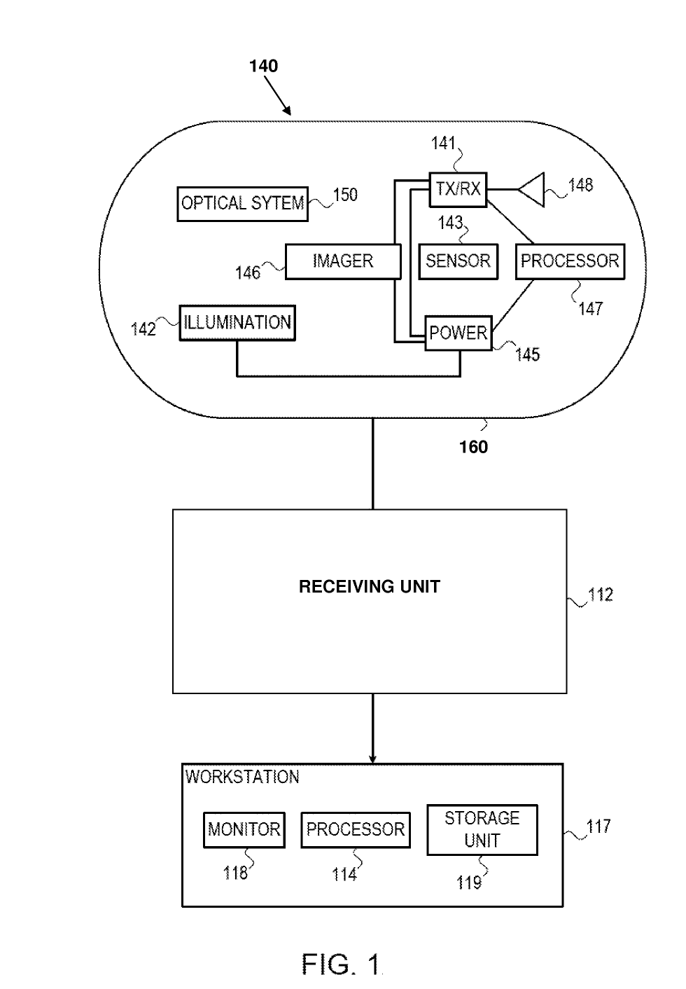

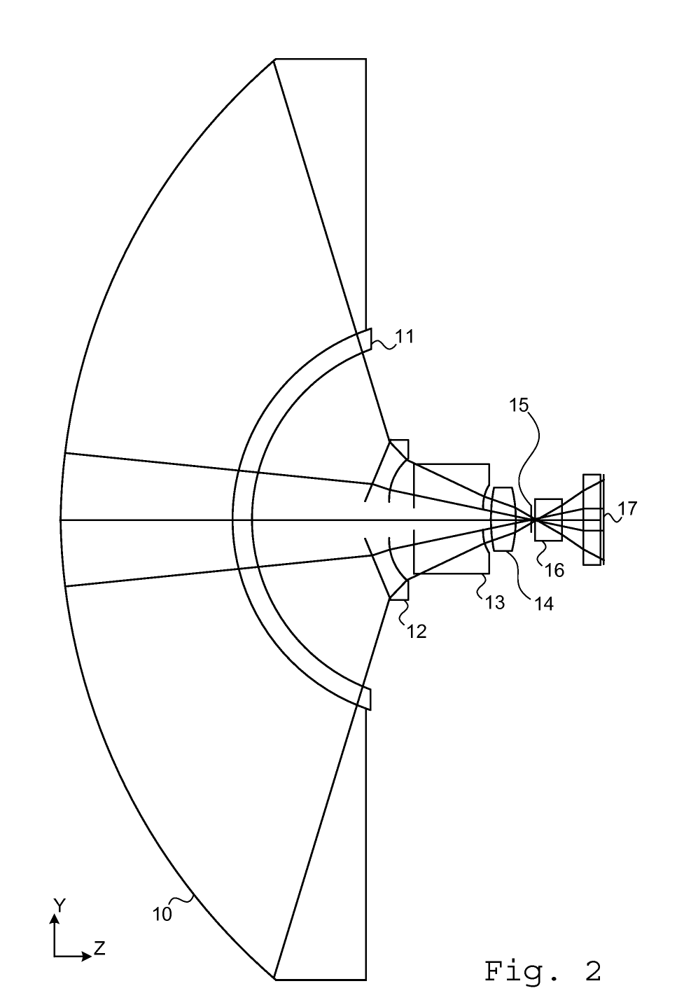

Reference is now made to FIG. 1 which illustrates schematically an exemplary swallowable capsule 140 incorporating double field of view imaging optics. The capsule 140 have an elongate or oblong housing 160 containing, for example, a sensor, e.g., an imager or camera 146, an optical system 150, one or more illumination sources (e.g. light emitting diodes) 142, a power source 145, processor 147, and a transmitter and/or transceiver 141 with an antenna 148, and an additional sensor 143. In some embodiments, device 140 may be implemented using a swallowable capsule, but other sorts of devices or suitable implementations may be used. Illumination may be transmitted via, and images may be received via, a dome or window for example at an end of the device (e.g. dome 11 in FIGS. 2-4). Camera 146 may be a two-dimensional detector array. Camera 146 may have a uniform array of pixels, but need not. Other housing shapes may be used. Sensors beyond imager or camera 146 need not be used.

Receiver/recorder 112 may include a receiver or transceiver to communicate with device 140, e.g., to send control data to device 140 and to periodically receive image, telemetry and device parameter data from device 140. Receiver/recorder 112 may include a memory to store image or other data. In some embodiments, for example in the case one-way communication is used, device 140 may include a transmitter and receiver/recorder 112 may include a receiver. Receiver/recorder112 may in some embodiments be a portable device worn on or carried by the patient, but in other embodiments may be for example combined with workstation 117. A workstation 117 (e.g., a computer or a computing platform) may include a storage unit 119 (which may be or include for example one or more of a memory, a database, or other computer readable storage medium), a processor 114, and a display or monitor 118.

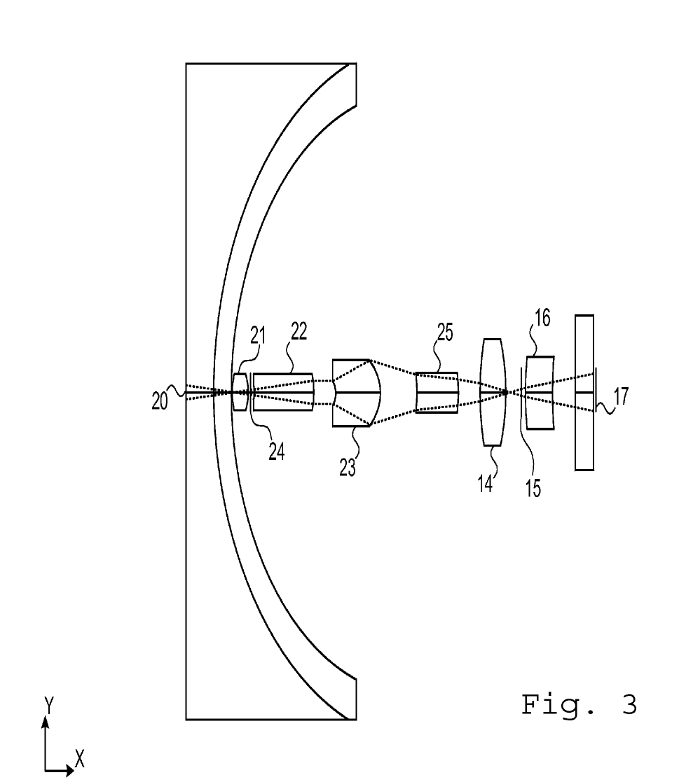

Reference is now made to FIG. 2, which illustrates schematically an exemplary imaging system or part of an imaging system, which may be used for example in capsule 140, for providing a wide field of view image of an object 10, at a low magnification level. The object can be for example from a few millimeters to 50 mm from the objective lens, for medical applications, and a large depth of focus can be achieved readily at wide fields because of the relatively low focal length and the readily selected f-number of the wide-field optics, which may be chosen by the optics designer, such that the higher the f-number, the larger the depth of focus is and vice versa. The imaging system of FIG. 2 may provide a first image of an object on the camera or detector array of FIG. 1, and may have or provide a different magnification relative to the object than the system of FIG. 3.

The field of view can cover angles of at least 100° and even up to 180°. FIG. 2 shows only half of the field of view, on one side of the optical axis only. The optical system in one embodiment includes four lenses, having optical apertures sufficient to collect the wide field of view. Other numbers of lenses and elements may be used. The system has an outer transparent window or dome 11 (e.g., located at one end of elongate housing 160) in order to protect it from the external environment. The optics power of the dome shown in the design of FIG. 2 is negligible, though in other embodiments it could have some significant level. The implementation shown in FIG. 2 is a conventional arrangement, having an objective lens, an intermediate or relay lens set, and a field lens. The objective lens 12 may reduce the range of field angles of the light from the object field and transfer the light to the collecting lens combination 13, 14, which is shown as a double lens in this exemplary implementation, whose function is to collect light on the aperture stop 15 and at the same time, to correct by virtue of their design, most of the optical aberrations. It is noted that lenses 12 and 13 may axial bores generated in their bodies, so that elements of the high magnification part of the system can be implanted therewithin, as will be explained herein. The wide-field aperture stop 15 is disposed in front of the field lens 16 whose function is to flatten the field curvature arising from the sharply curved object wavefront. Finally the focused image falls on the detector array 17 (which may for example correspond to imager or camera 146) which can be a CMOS or a CCD pixilated array typically having from 200×200 pixels to 1000×1000 pixels. Other sizes, shapes, dimensions, and pixel numbers may be used for the imager or array. If the design is constructed for IR viewing the detector may be an Infra-Red imager, such as a bolometric or Mercury Cadmium Telluride (MCT) array.

Reference is now made to FIG. 3, which illustrates schematically an exemplary imaging system or part of an imaging system for providing a narrow field of view image of part 20 of the object, at a high magnification level. The imaging system of FIG. 3 may provide a second image of an object on the camera or detector array of FIG. 1, and may have or provide a different magnification relative to the object than the system of FIG. 2. The magnification provided by the system of FIG. 3 may have a magnification greater than or substantially greater than the magnification provided by the system of FIG. 2. The image produced by the system of FIG. 2 may provide a substantially higher amount of total details of the object than the image provided by the system of FIG. 3 because it may image over a wider area (the relative areas imaged by the systems may differ in different embodiments). Conversely, the system of FIG. 3 with higher magnification and a narrow field of view may produce more resolution (e.g., more detail per area imaged), while imaging over a smaller area.

The size of that part of the object 20 being imaged can be for example from 100×100 microns to 2×2 mm depending on the optical design (other ranges may be used), and the focal distance can range from the dome apex and beyond. The important feature for the narrow-field optics is that its elements in some embodiments may have diameters as small as possible, to minimize the obstruction to the wide field optics effective aperture, and still insure the relatively high, narrow-field object numerical aperture needed for high magnification. The narrow-field optics can include any number of lenses and of any kind, part of them being common with wide-field optics. The exemplary optical system shown in FIG. 3 contains 6 effective elements; other numbers of lenses and elements may be used. The objective or collection lens 21 is responsible for providing the numerical aperture needed for the high magnification, and projects the collected light from the object through the narrow-field aperture stop 24 and into a pair of lenses 22, 23 whose function may be two-fold—(i) to correct for aberrations arising from the objective lens and (ii) to act as a relay lens in order to project an intermediate image to compensate for the length of the optical system, being so much longer than the effective focal length of the objective lens. The function of lens 25 may be three-fold: (i) to provide the desired focal length in conjunction with the other lenses in the system, (ii) to project the intermediate image onto the detector array, and (iii) to limit the diameter of the ray bundle to prevent vignetting as they pass through the stop 15 of the low magnification system of FIG. 2. Other or different functions may occur. Finally, the field lens may 16 flatten the field curvature arising from the sharply curved object wavefront, and the focused image falls on the detector array 17.

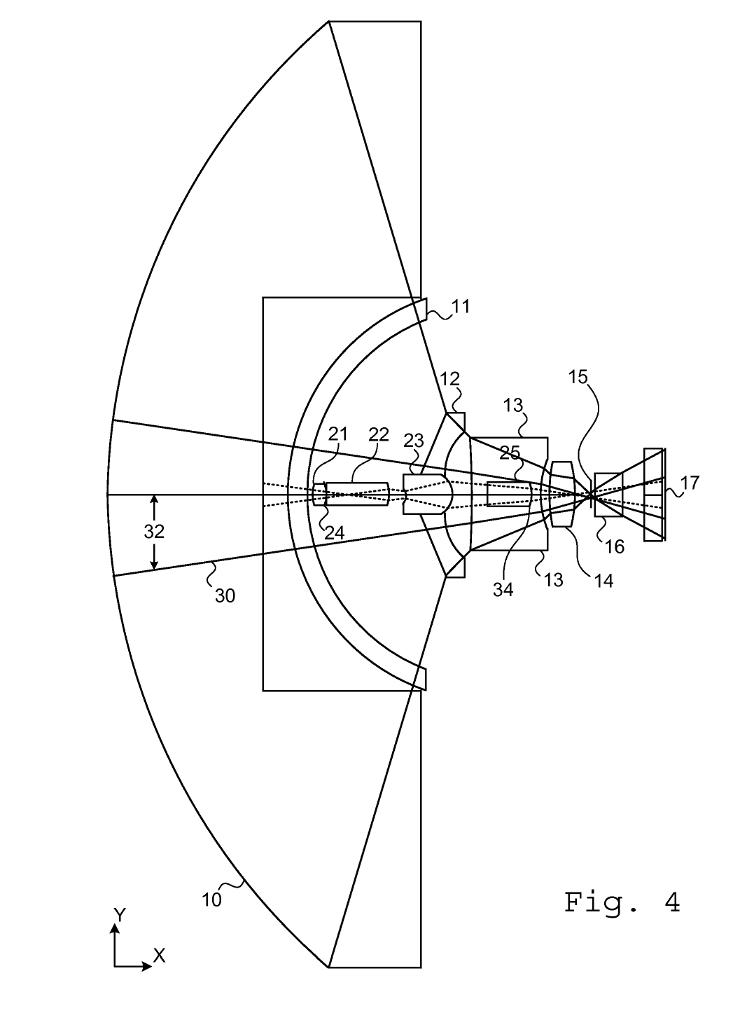

Reference is now made to FIG. 4, which illustrates schematically an exemplary imaging system obtained by combining the systems shown in FIGS. 2 and 3, into one composite system having a double field of view function. The combined system may be used in the device shown in FIG. 1. The narrow field of view imaging system may include lenses disposed axially within the wide field of view imaging system, and both of the imaging systems may use at least one common lens to project an image onto the detector array.

The combined system contains a number of lenses dedicated to their specific imaging system whether low magnification or high magnification, and two shared or common lenses 14 and 16, which may be used by both component optical systems. Common lenses 14 and 16 are in front of detector array 17 in the sense that lenses 14 and 16 are between detector array 17 and the object to be imaged, and/or that lenses 14 and 16 are located in the direction of viewing of detector array 17. The lenses are labeled as per their functions in FIGS. 2 and 3. Other numbers of common lenses may be used. Lenses 23 and 12 can either be formed of a single molded element or lens 23 can be a separate element inserted into a bore in lens 12. Lens 25 may be an individual lens inserted into a bore in lens 13 to its correct position. When using the low magnification system, it is noted that because of the presence of the high magnification components, disposed along the axis of the system, it may be impossible to obtain an image of the entire field of view. The central region is blocked by these components. The most axial ray 30 which can be imaged on the detector by the low magnification system is that which just skirts the innermost edge of lens 25, at the point marked 34. Light originating in the object from a direction more axially than ray 30 may not be imaged, and this is known as a dead zone of the lower magnification system. FIG. 4 shows only half of the field of view, on one side of the optical axis only, such that only half 32 of the dead zone is shown. The dead zone can typically be from 5° to 20° on either side of the optical axis (other ranges are possible). The high magnification system on the other hand is unobstructed, and this image is therefore seen in its entirety.

In use, the distance of the system from the object may generally be used as a parameter for determining whether the high magnification image is focused on the imaging array. The low magnification image may be constantly in focus as its focus may not depend (or may not depend as much) on the distance of the system from the object. Changing focus of the high magnification image may be performed by simply moving the system closer (focused high magnification) or further (defocused high magnification) from the object. In order to keep the system focused at the point of interest without the need to move the entire system, a focusing drive may be coupled to one of the lenses. For the high magnification field of view, this adjustment may be used because of the high sensitivity of imaging quality to focal length. A mis-adjustment of only 0.1 mm. could be sufficient to ruin the focus and the sharpness of the image. The correct focus may be obtained by visual observation of the image and its adjustment by the observer, or an autofocus mechanism can be used, with a motor drive to the adjusted lens. Such an autofocus mechanism could be based for instance on signal processing of the edge sharpness's of the image.

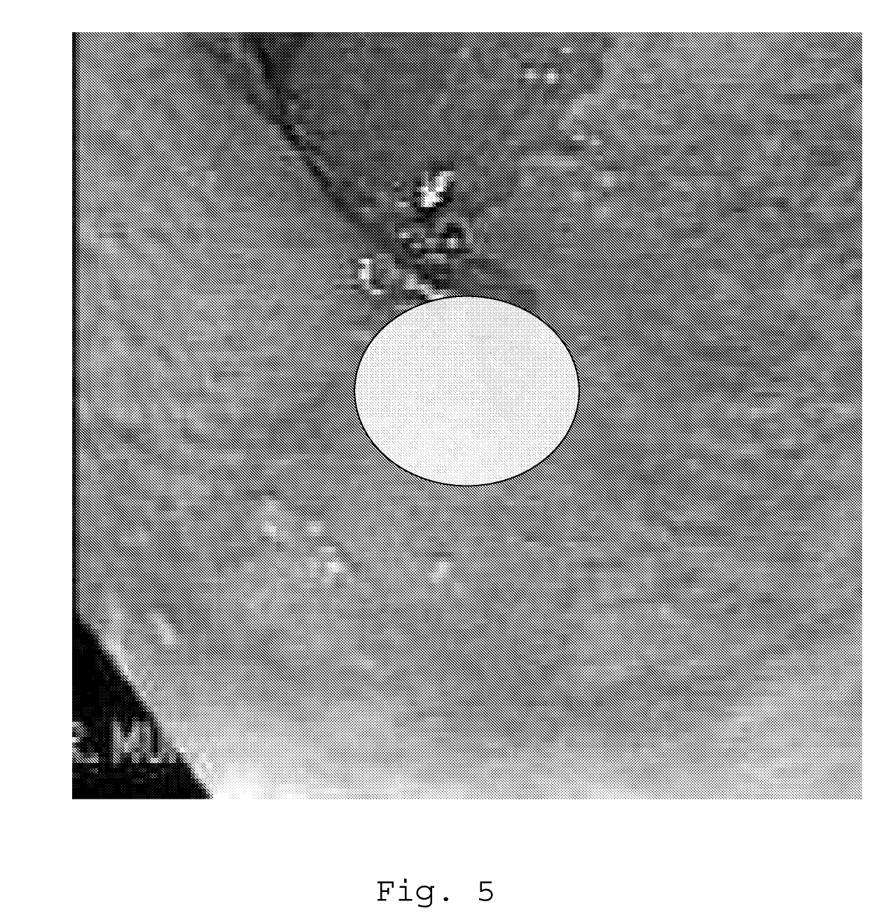

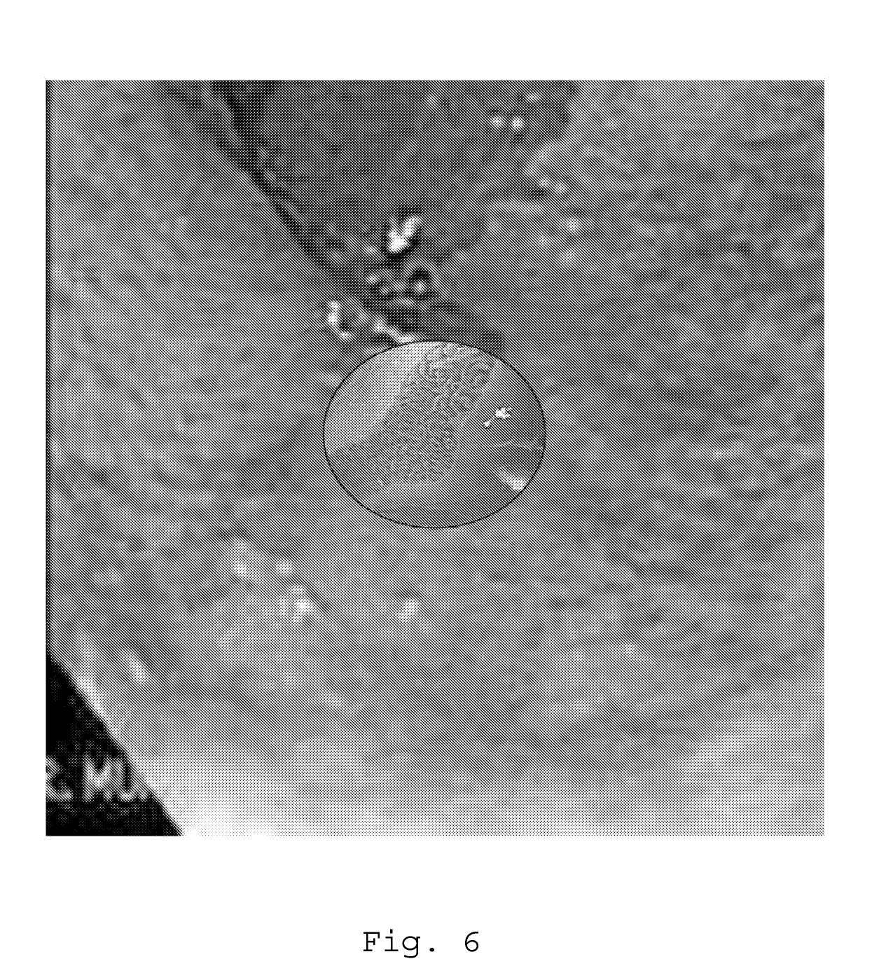

A composite image may be created, with a high magnification image occupying the central section of the composite image and a low magnification occupying the periphery of the composite image. Reference is now made to FIGS. 5 and 6, which illustrate examples of the images seen on the display of such a system, when the system is disposed at such a distance from the object that the high magnification image is optimized (FIG. 6). As is observed, the central region of the display shows a focused image of the object at high magnification, with the peripheral regions of the display showing the wide field of view, lower magnification image (FIG. 6). As the system is moved away from the object, the central high magnification image becomes defocused, as shown in FIG. 5. In other embodiments such movement need not be used to focus the images.

### EXAMPLES

Reference is now made to Table I, which provides specifications and prescription data for one exemplary implementation of the low magnification, wide field of view section of an optical system such as is described in FIG. 2 of this application. Other implementations are possible. The results of the design iteration are given from the program output without rounding. This exemplary lens assembly contains 4 lenses and 3 elements without optical power, whose optical parameters have been optimized using the ZEMAX® optimization program. This exemplary system has been designed to provide a 130° total field of view. The effective focal length is 1.24823 mm, and the back focal length to the imager plane is 0.53858 mm. The total optical track length is 10.699 mm, and the paraxial working f/number is 5.51225. All dimensions are in mm.

TABLE I

| Surface | Type | R ° C. | Thickness | Material | Diameter | Conic Coefficient |
|---|---|---|---|---|---|---|
| OBJ | STANDARD | 17.5 | 5 | Water | 26.7788 | 0 |
| 1 | EVENASPH | 5.92649 | 0.5 | Polycarb. | 11.02 | −0.1148121 |
| 2 | EVENASPH | 5.46223 | 3.22689 | Air | 9.64 | −0.5737734 |
| 3 | EVENASPH | 1.17266 | 0.78587 | Polycarb. | 4.64 | −3.95718 |
| 4 | EVENASPH | 0.80443 | 0.78014 | Air | 3.54 | −277.4507 |
| 5 | EVENASPH | −3.78514 | 1.92119 | Polycarb. | 3.2 | 0 |
| 6 | EVENASPH | 3.89236 | 0.24443 | Air | 1.92 | 0 |
| 7 | EVENASPH | 5.39346 | 0.73595 | E48R | 1.8 | 0 |
| 8 | EVENASPH | −1.64289 | 0.43245 | Air | 1.8 | 0 |
| STO | STANDARD | ∞ | 0.09857 | Air | 0.4 | 0 |
| 10 | EVENASPH | 1.45985 | 0.78176 | E48R | 0.76 | 11.91922 |
| 11 | EVENASPH | −26.5725 | 0.64743 | Air | 1.2 | 0 |
| 12 | STANDARD | ∞ | 0.5 | N-BK7 | 2.6 | 0 |
| 13 | STANDARD | ∞ | 0.045 | Air | 2.6 | 0 |
| IMA | STANDARD | ∞ | — | Air | 2.52119 | 0 |

OBJ is the objective front surface, STOP is the aperture stop and IMA is the imaging array plane, and the refractive indices of the media are given, at the 550 nm wavelength used, and at 30 deg. C. as:

### Water—1.334333, Polycarbonate—1.588515, and N-BK7—1.518551

Using the standard aspheric sag equation:

$$Z = \frac{{ch}^{2}}{1 + \sqrt{( 1 - ( 1 + k ) {c}^{2}} {h}^{2} )} + {a}_{4} {h}^{4} + {a}_{6} {h}^{6} + {a}_{8} {h}^{8} + {a}_{10} {h}^{10} + {a}_{12} {h}^{12} + …$$

where
Z is the sag of the surface at any point,
h is the height from the optical axis,
c=1/R, where R is the equivalent spherical radius of curvature at the surface vertex,
k is the conic coefficient (=0 for a spherical surface), and
a₄, a₆, a₈, . . . are the 4^{th}, 6^{th}, 8^{th} . . . order aspheric coefficients,
the following prescription is obtained for the 14 surfaces:

| Surface | a₄ | a₆ | a₈ | a₁₀ | a₁₂ |
|---|---|---|---|---|---|
| OBJ | 0 | 0 | 0 | 0 | 0 |
| 1 | 0.0003032 | 5.5499 × 10⁻⁶ | 3.0166 × 10⁻⁸ | −4.1707 × 10⁻⁹ | 0 |
| 2 | 0.0008827 | 1.000 × 10⁻⁵ | 1.3249 × 10⁻⁶ | 2.4933 × 10⁻⁸ | 0 |
| 3 | 0.0069438 | −0.0001116 | 2.1553 × 10⁻⁶ | 0 | 0 |
| 4 | 0.015799 | −0.0146184 | 0.0078339 | −7.0227 × 10⁻⁵ | 0 |
| 5 | 0.060842 | −0.0003852 | −8.9565 × 10⁻⁵ | −0.0005604 | −0.0021730 |
| 6 | 0.0788792 | −0.0049461 | −0.0190166 | −0.0065401 | −0.0007168 |
| 7 | 0.0150449 | 0.0425029 | 0.0382886 | −0.0037392 | 0 |
| 8 | 0.123396 | −0.030988 | 0.093516 | 0 | 0 |
| STO | 0 | 0 | 0 | 0 | 0 |
| (Minimum | | | | | |
| radius = 0.2 mm.) | | | | | |
| 10 | −0.316956 | −0.366602 | −20.1960 | 0 | 0 |
| 11 | 0.159906 | 0.321203 | 0 | 0 | 0 |
| 12 | 0 | 0 | 0 | 0 | 0 |
| 13 | 0 | 0 | 0 | 0 | 0 |
| IMA | 0 | 0 | 0 | 0 | 0 |

Reference is now made to Table II, which provides specifications and prescription data for an exemplary implementation of the high magnification, narrow field of view section of an optical system such as is described in FIG. 3 of this application. This exemplary lens assembly contains 6 lenses and 4 elements without optical power, and all optical parameters have been optimized using the ZEMAX® optimization program. This example has been designed to provide a resolution of 2 microns, and a field of view of 0.2 mm at 0.2 mm. The effective focal length is 0.64173 mm. The total optical track length is 10.699 mm, intentionally kept identical to that of the low magnification example, and the paraxial working f/number is 7.2675.

TABLE II

| Surface | Type | R ° C. | Thickness | Material | Diameter | Conic Coefficient |
|---|---|---|---|---|---|---|
| OBJ | STANDARD | Infinity | 0.8 | WATER | 0.26 | 0 |
| 1 | EVENASPH | 5.926491 | 0.5 | POLYCARB | 1.02 | −0.1148121 |
| 2 | EVENASPH | 5.462229 | 0 | Air | 9.64 | −0.5737734 |
| 3 | STANDARD | 0.5664545 | 0.4597685 | E48R | 0.6 | −1.683049 |
| 4 | STANDARD | −0.4007237 | 0.07546284 | Air | 0.6 | −3.588625 |
| STO | STANDARD | Infinity | 0.09552406 | Air | 0.259404 | |
| 6 | STANDARD | −0.5448025 | 1.68528 | POLYCARB | 0.36 | −11.26473 |
| 7 | STANDARD | −0.6723586 | 0.5968567 | Air | 0.6 | −1.596795 |
| 8 | EVENASPH | −0.3267467 | 1.240316 | POLYCARB | 0.42 | 0.6211092 |
| 9 | EVENASPH | −0.5332203 | 1.046699 | Air | 1.1 | −0.60936 |
| 10 | EVENASPH | −2.00697 | 1.159998 | POLYCARB | 0.66 | 0 |
| 11 | EVENASPH | −2.184586 | 0.2993119 | Air | 0.66 | 23.86846 |
| 12 | STANDARD | Infinity | 0.2993114 | Air | 0.5334175 | 0 |
| 13 | EVENASPH | 5.393463 | 0.735948 | E48R | 1.8 | 0 |
| 14 | EVENASPH | −1.642893 | 0.4324515 | Air | 1.8 | 0 |
| 15 | STANDARD | Infinity | 0.09857038 | Air | 0.3049238 | 0 |
| 16 | EVENASPH | 1.459849 | 0.7817586 | E48R | 0.76 | 11.91922 |
| 17 | EVENASPH | −26.57247 | 0.6474324 | Air | 1.2 | 0 |
| 18 | STANDARD | Infinity | 0.5 | N-BK7 | 2.6 | 0 |
| 19 | STANDARD | Infinity | 0.045 | Air | 2.6 | 0 |
| IMA | STANDARD | Infinity | 0.5943416 | Air | | 0 |

OBJ is the objective front surface, STOP is the aperture stop and IMA is the imaging array plane, and the refractive indices of the media are given, at the 550 nm wavelength used, and at 30 deg. C. as:

### Water—1.334333, Polycarbonate—1.588515, and N-BK7—1.518551

Using the standard aspheric sag equation described above, the following prescription is obtained for the 20 surfaces:

| Surface | a₄ | a₆ | a₈ | a₁₀ | a₁₂ |
|---|---|---|---|---|---|
| OBJ | 0 | 0 | 0 | 0 | 0 |
| 1 | 0.0003032 | 5.5499 × 10⁻⁶ | 3.0166 × 10⁻⁸ | −4.1707 × | 0 |
| | | | | 10⁻⁹ | |
| 2 | 0.0008827 | 1.000 × 10⁻⁵ | 1.3249 × 10⁻⁶ | 2.4933 × | 0 |
| | | | | 10⁻⁸ | |
| 3 | 0 | 0 | 0 | 0 | 0 |
| 4 | 0 | 0 | 0 | 0 | 0 |
| 5 | 0 | 0 | 0 | 0 | 0 |
| 6 | 0 | 0 | 0 | 0 | 0 |
| 7 | 0 | 0 | 0 | 0 | 0 |
| 8 | 0 | 0 | 0 | 0 | 0 |
| 9 | 0 | 0 | 0 | 0 | 0 |
| 10 | 0 | 0 | 0 | 0 | 0 |
| 11 | 0 | 0 | 0 | 0 | 0 |
| 12 | 0 | 0 | 0 | 0 | 0 |
| 13 | 0.0150449 | 0.0425029 | 0.0382886 | −0.0037392 | 0 |
| 14 | 0.123396 | −0.030988 | 0.093516 | 0 | 0 |
| STO | 0 | 0 | 0 | 0 | 0 |
| 16 | −0.316956 | −0.366602 | −20.1960 | 0 | 0 |
| 17 | 0.159906 | 0.321203 | 0 | 0 | 0 |
| 18 | 0 | 0 | 0 | 0 | 0 |
| 19 | 0 | 0 | 0 | 0 | 0 |
| IMA | 0 | 0 | 0 | 0 | 0 |

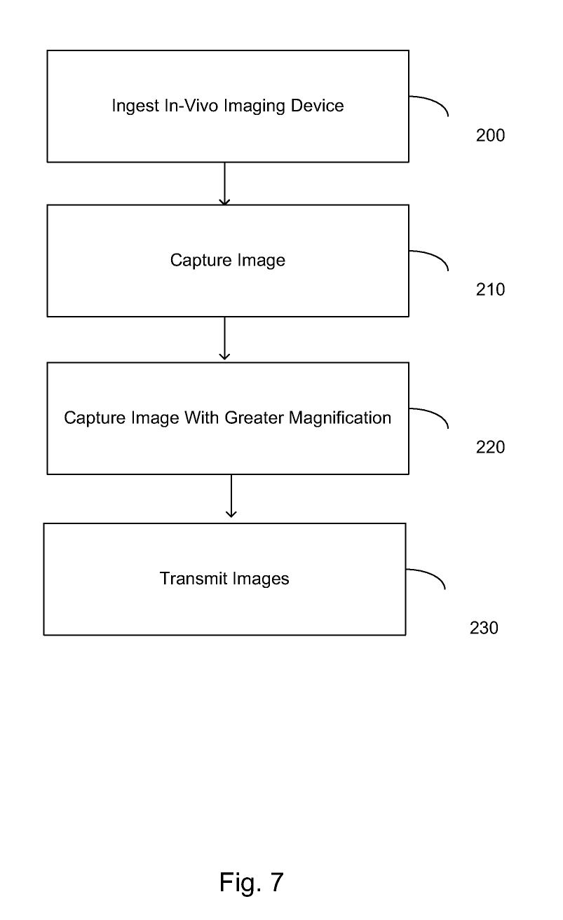

FIG. 7 is a flowchart illustrating a method according to one embodiment of the invention.

In operation 200 a patient may swallow or otherwise ingest an in-vivo imaging device (e.g., a capsule) including a camera or two-dimensional detector array.

In operation 210 an image of an object (e.g., a section of a body lumen, a suspected pathology, etc.) may be captured on the array. The image may have a certain magnification relative to the object.

In operation 220 a second image of an object (e.g., a section of a body lumen, a suspected pathology, etc.) may be captured on the array. The image may have a certain magnification relative to the object, the magnification greater than, or substantially greater than, the image captured in operation 210.

Operations 210 and 220 may be performed concurrently or simultaneously, according to the operation of the device.

In operation 230 the images may be transmitted, for example to an external data recorder or receiver. The images may be transmitted as a combined or composite image, for example in one image frame.

Other operations or series of operations may be used.

It is appreciated by persons skilled in the art that the present invention is not limited by what has been particularly shown and described hereinabove. Rather the scope of the present invention includes both combinations and sub-combinations of various features described hereinabove as well as variations and modifications thereto which would occur to a person of skill in the art upon reading the above description and which are not in the prior art.

1. An in-vivo imaging device comprising:
a source for illumination; and
an optical imaging system comprising:
a two-dimensional detector array;
a wide field of view imaging system for providing a first image of an object on said detector array, said first image having a first magnification relative to said object; and
a narrow field of view imaging system for providing a second image of part of said object on said detector array, said second image of part of said object having a second magnification substantially greater than said first magnification,
wherein said narrow field of view imaging system comprises lenses disposed axially within said wide field of view imaging system, and wherein both of said imaging systems utilize at least one common lens to project an image onto said detector array.

2. A device according to claim 1, wherein said detector array has a uniform array of pixels, and said second image is capable of providing substantially higher resolution than said first image by virtue of the substantially higher magnification of said narrow field of view system.

3. A device according to any of the previous claims, wherein said detector array provides a composite image with said second image occupying the central section of the composite image, and said first image occupying the periphery of the composite image.

4. A device according to claim 3, wherein each part of said composite image can be brought into focus by moving said system relative to said object.

5. A device according to claim 3, wherein each part of said composite image can be focused without the need to move the system relative to the object.

6. A device according to claim 1, wherein said at least one common lens comprises a lens disposed in front of said detector array for focusing both of said first and said second images onto said array.

7. A device according to any of the previous claims, wherein said detector array is any one of a CCD array and a CMOS array.

8. A device according to any of claims 1 to 6, wherein said detector array is an IR imaging array

9. A device according to any of the previous claims, wherein said second image has a magnification substantially larger than that of said first image.

10. A device according to claim 9, wherein said range of magnification is obtained without a zoom mechanism.

11. A method for in-vivo imaging comprising:
using a device comprising a two-dimensional detector array,
capturing a first image of an object on the detector array, the first image having a first magnification relative to said object; and
capturing a second image of part of the object on the detector array, the second image having a second magnification substantially greater than said first magnification.

12. The method of claim 11 comprising transmitting the first image and the second image.

13. The method of claim 11, wherein the device comprises a wide field of view imaging system and a narrow field of view imaging system, and wherein the first image is captured by the wide field of view imaging system and the second image is captured using the narrow field of view imaging system.

14. The method of claim 11, wherein the narrow field of view imaging system comprises lenses disposed axially within said wide field of view imaging system, and wherein both of the imaging systems use at least one common lens to project an image onto the detector array.

15. The method of claim 11, wherein the second image has a higher resolution than the first image.

16. The method of claim 11, comprising creating a composite image with the second image occupying the central section of the composite image and the first image occupying the periphery of the composite image.

17. The method of claim 11, wherein said at least one common lens comprises a lens disposed in front of said detector array for focusing both of said first and said second images onto said array.
